(19) United States
(12) Patent Application Publication
(10) Pub. No.: US 2014/0157486 A1
(43) Pub. Date: Jun. 12, 2014

(54) Glove for capacitive touchscreen interface and methods

(71) Applicants: Bernardo Antonio Del Rio Audibert, Mexico (MX); Jean Aime Roland Del Rosal Aliaga, Mexico (MX)

(72) Inventors: Bernardo Antonio Del Rio Audibert, Mexico (MX); Jean Aime Roland Del Rosal Aliaga, Mexico (MX)

(21) Appl. No.: 13/934,208

(22) Filed: Jul. 2, 2013

(51) Int. Cl. G06F 3/01

(52) U.S. Cl. CPC G06F 3/014
USPC 2/161.2

(57) ABSTRACT

An athletic glove system for interface with a capacitive touchscreen as a human hand is received therein. The athletic glove system includes a hollow flexible body member and a plurality of glove stalls, including a finger glove stall, each attached to and projecting from the hollow flexible body member. The finger glove stall includes an inner finger surface, an outer finger surface, and a conductive layer positioned between the inner and outer finger surfaces. The conductive layer defines a matrix of interstices that includes a conductive layer pathway. The conductive layer pathway is configured to move electrically conductive bodily fluids emitted by the skin of the human hand from the inner finger surface to the outer finger surface. The electrically conductive bodily fluids exit the conductive layer pathway at the outer finger surface to establish a change in capacitance at the capacitance touchscreen to operate the touchscreen.

### BACKGROUND OF THE INVENTION

1. Technical Field

The present invention generally relates to a glove provided for a human hand. More particularly, but not by way of limitation, the present invention relates to a glove used in sporting events, such as golf, that is configured to successfully interface with an mobile device or other user equipment that operates on computer-based instructions.

2. Description of Related Art

Generally, many athletes wear gloves to improve grip while protecting their skin. Often the gloves are fitted tightly to the wearer's hand to afford appreciable grip while in use during an athletic event.

Illustratively, while swinging a small ball with a club, a golfer often wears a single golf glove on the hand that grips the distal end of the club's shaft. As such, during the game of golf, the golf glove facilitates appreciable grip while swinging the club and protects the skin of the golfers' hand from frictional wear, such as among others protection from calluses and blisters, while forcefully swinging the club.

During frequent inactive periods where golfers are not in-play, especially while in transit between holes or waiting for the vacancy of a subsequent of a hole, golfers will often chat, conduct business, make a phone call, and go online for these periods during a single game of golf that typically lasts several hours. Unfortunately, during this time, today's golfers often must entirely remove their golf glove to sufficiently interface with the touchscreens of many mobile devices. This ongoing problem continues to repeat as the hours go by during a golf game.

Capacitive touchscreens are a key input/output display component of many today's mobile devices, such as among others smart phones, tablets, netbooks, geolocation devices, and laptops. Specifically, capacitive touchscreens are solely activated based on a change in capacitance relative to the touchscreen. The dielectric effect associated with human body, in particular such as a body's skin and bodily fluids, often provides sufficient change in capacitance so as to successfully operate a nearby capacitive touchscreen. However athletic gloves, such as golf gloves, often act as electrical insulators that sufficiently obscure the dielectric conductive properties naturally associated with the wearers' body thereby preventing successful operation of those mobile devices including capacitive touchscreens.

Unfortunately, there is no known golf glove for successfully interfacing with a capacitive touchscreen, such as the input/output display of a mobile device. Moreover, there is no known athletic glove for establishing a conductive path between a capacitive touchscreen and the human hand that capitalizes on the natural dielectric properties of the human body, such as among others the bodily fluids emitted from the skin of the hand.

### SUMMARY

Generally speaking, pursuant to various embodiments, aspects of the present disclosure provide an athletic glove for receiving a human hand. The athletic glove is configured to interface with a capacitive touchscreen as a human hand is received by the athletic glove. The athletic glove includes a hollow flexible body member and a plurality of glove stalls each attached to and projecting from the hollow flexible body member. The hollow flexible body member has an access portion, a front portion, and a back portion. The front portion includes a palm area. The back portion includes a knuckle area. In one aspect, the hollow flexible body member defines the access portion configured to receive the human hand therethrough and is opposingly located, on the hollow flexible body member, from the plurality of glove stalls. The plurality of glove stalls includes at least one finger glove stall and a thumb glove stall, each attached to and projecting from the hollow flexible body member opposite the access portion.

In one aspect, the finger glove stall includes an inner finger surface, an outer finger surface, and a conductive layer positioned between the inner and outer finger surfaces. The conductive layer defines a matrix of interstices at least one interstices of the matrix of interstices includes a conductive layer pathway.

The conductive layer pathway is configured to move electrically conductive bodily fluids emitted by the skin of the human hand from the inner finger surface to the outer finger surface. The electrically conductive bodily fluids exit the conductive layer pathway at the outer finger surface to establish a change in capacitance at the capacitance touchscreen to operate the touchscreen.

In one further aspect, the athletic glove includes a collector layer, disposed on the at least one interstice of the matrix of interstices, that receives electrically conductive bodily fluids and stores electrically conductive bodily fluids from inner finger surface to the outer finger surface. In one aspect, the collector layer is composed at least in part of polyacrylamide.

In one further aspect, a golf glove for receiving a human hand is provided. Similar to the athletic glove described above, the golf glove includes a hollow flexible body member and a plurality of glove stalls that includes a finger glove stall. The finger glove stall includes an inner finger surface, outer finger surface, and a conductive layer. The conductive layer includes a conductive layer pathway configured to move electrically conductive bodily fluids to establish a change in capacitance. Other aspects, advantages, and novel features of the present invention will become apparent from the detailed description of the present invention when considered in conjunction with the accompanying drawings.

### DESCRIPTION OF THE DRAWINGS

The present invention is illustrated by way of example and not by limitation in the accompanying figures, in which like references indicate similar elements, and in which:

FIG. 1 is an schematic view from the side of an athletic glove, such as a golf glove among others, of the present disclosure for interfacing with a capacitive touchscreen having at least one finger glove stall;

FIG. 2 is a schematic view of one embodiment of an athletic glove illustrating a back portion including a knuckle area;

FIG. 3 is a schematic view of one embodiment of an athletic glove featuring a front portion having a palm area, the athletic glove including a conductive layer that defines a matrix of interstices;

Generally, FIG. 4 is a schematic view of one embodiment of an athletic glove, such as a golf glove, featuring a conductive layer pathway to move electrically conductive bodily fluids directly from the hand to the outer surface of the athletic glove to establish a change in capacitance at the capacitive touchscreen to operate the touchscreen and FIG. 4a is a detailed view of a finger within a finger glove stall that includes a conductive layer positioned between an inner finger surface that is adjacent to the finger and an outer finger surface that is adjacent to the surface of the capacitive touchscreen;

FIG. 5 is a plan view from the side illustrating a conductive layer pathway for establishing a change in capacitance, the conductive layer pathway formed by an interstice from a matrix of interstices as shown;

FIG. 6 is a plan view from the side featuring a collector layer pathway for establishing continuous conductivity for one embodiment of an athletic glove to operatively interface with a capacitive touchscreen; and

FIG. 7 is a plan view from the side illustrating a collector valve to regulate electrically conductive bodily fluid flow to establish continuous operability for an athletic glove to interface with a capacitive touchscreen.

Skilled artisans appreciate that elements in the Figures are illustrated for simplicity and clarity and have not necessarily been drawn to scale. For example, the dimensions of some of the elements in the Figures may be exaggerated relative to the other elements to help improve understanding of the embodiments of the present invention.

### DETAILED DESCRIPTION

For a more complete understanding of the present invention, preferred embodiments of the present invention are illustrated in the Figures Like numerals being used to refer to like and corresponding parts of the various accompanying drawings. It is to be understood that the disclosed embodiments are merely exemplary of the invention, which may be embodied in various forms.

In this disclosure and appended claims the term “electrically conductive bodily fluids” refers to fluids emitted from the skin having dissolved salts that establish a path of electrical conductivity directly to the skin whereby the skin had dielectric properties due to associated dissolved salts thereof. In this disclosure and appended claims, the term “collector” refers to an article of manufacture with the primary purpose of gathering dissolved salts from human skin to establish an electrically conductive path from the skin source. In this disclosure and appended claims the term “valve” refers to a flow regulator of a predetermined flow rate.

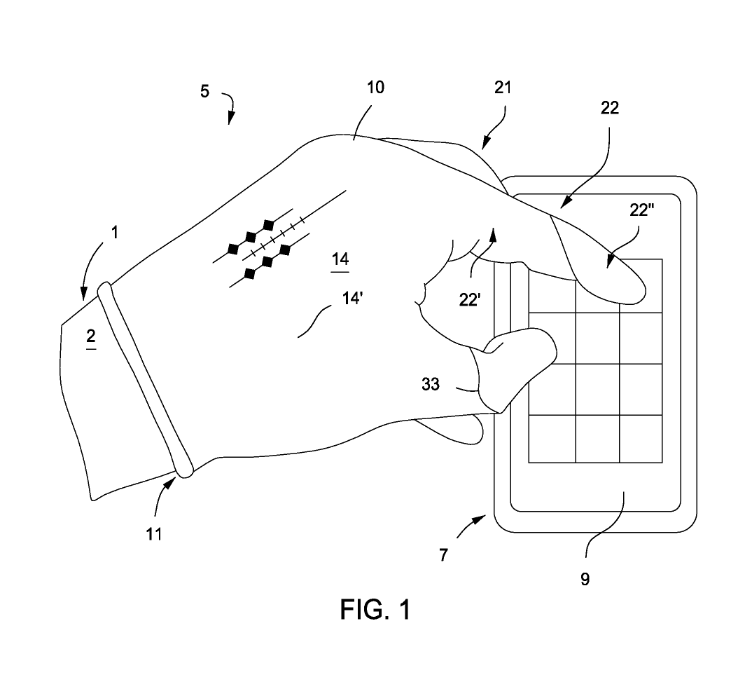

FIGS. 1-4 and 5-7 show various embodiments of an athletic glove system 5. Generally, the athletic glove system 5 is operatively applied to a variety of applications, including among others activities that require a work glove such as among others an oilfield work glove as well as a farming work glove.

In general, the athletic glove system 5 is operatively applied to several athletic and sporting activities including football, cycling, weight training and toning, hunting, fishing, skiing, motor sports such as motorcycle and automobile racing, rugby, baseball, softball, tennis, bowling, and volleyball among others. Those of ordinary skill in the art will readily recognize a variety of applications that require mitigating or eliminating frictional wear to the surface of the skin and establishing an interface for operating a capacitive touchscreen.

For purposes of illustration in this specification and appended claims, the athletic glove system 5 comprises a golf glove system 5 such that the athletic glove system 5 and the golf glove system 5 are understood to be interchangeable in the narrative of the specification provided below but is understood that the athletic glove system 5 includes other applications in addition to golf, such as football, baseball, athletic weight training, and other athletic and sporting activities, such as those listed above among others.

Accordingly, FIG. 1 specifically illustrates one example of an athletic glove system 5 comprising a golf glove system 5 having a body member 10. The body member 10 is flexible and hollow to receive a human hand 1 as shown. As shown, the body member 10 is secured tightly against skin 2 of the human hand 1. Generally, in operation, the golf glove system 5 is configured to interface with a capacitive touchscreen 9 as the human hand 1 is received by the golf glove 5.

In general, capacitive touchscreens 9 are a key input/output display component of user equipment 7 that includes mobile devices. In this application and appended claims, the term “user equipment” refers to any computer based device used directly by an end-user to communicate and/or obtain information. Those of ordinary skill in the art will readily recognize various embodiments of user equipment, for purposes of illustration in this disclosure, the user equipment 7 comprises either a wireless mobile device, such as among others a smartphone or a tablet computer, or a wired device, such as among others a desktop computer, workstation, or a kiosk whereby each device includes a capacitive touchscreen.

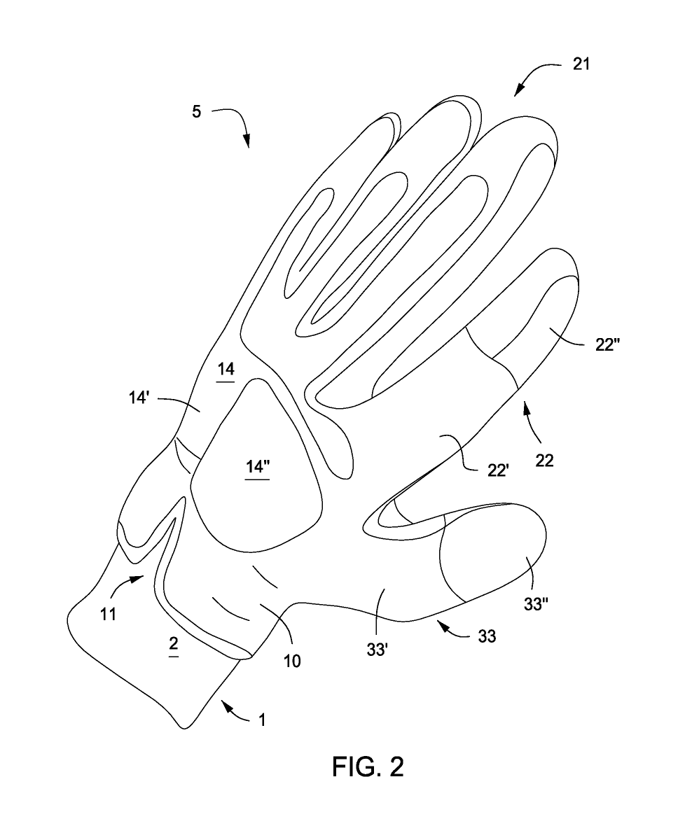

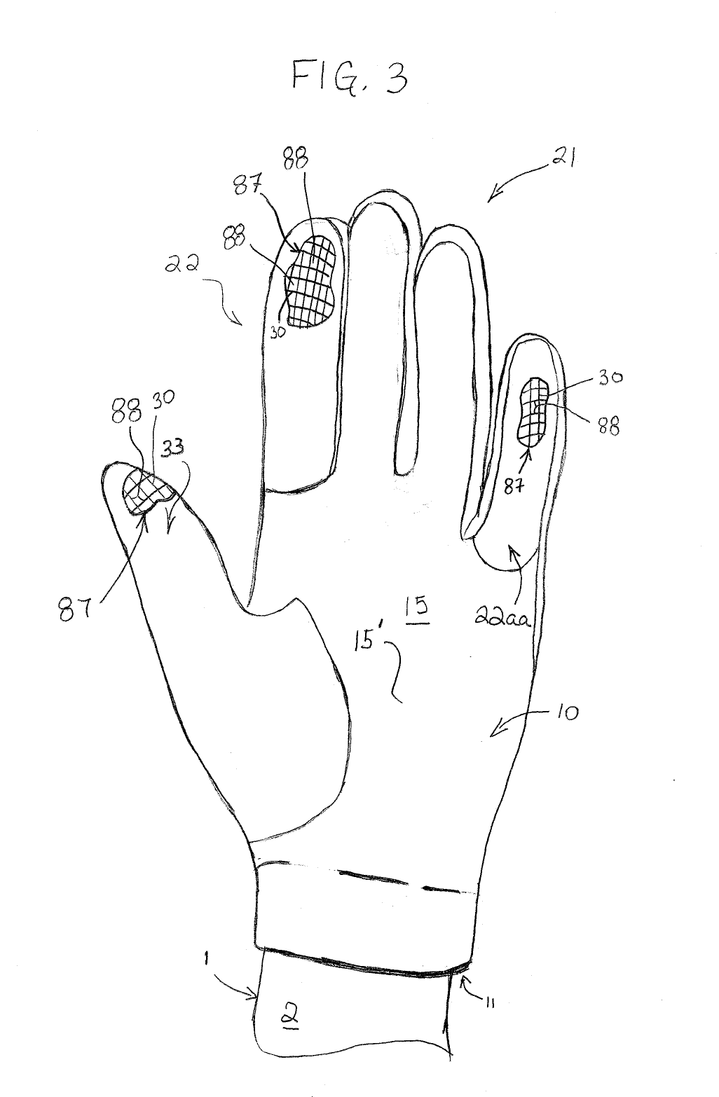

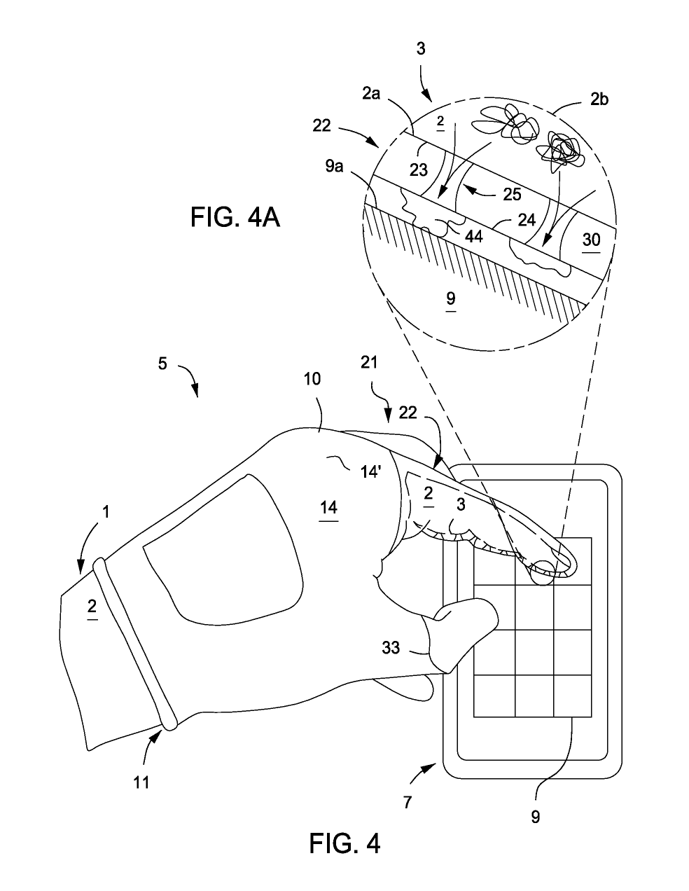

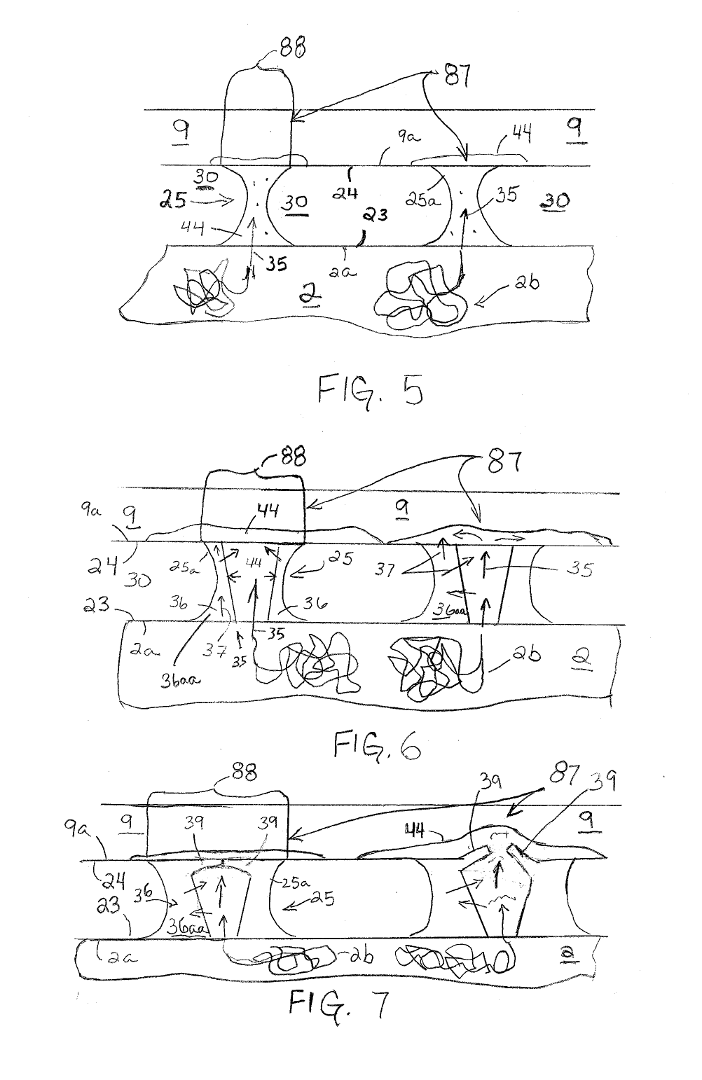

As shown in FIGS. 2 and 3, the body member 10 includes a back portion 14, a front portion 15, and an access portion 11. The access portion 11 provides an aperture for receiving the human hand 1 therethrough so that the golf glove system 5 is disposed on the human hand 1. As shown, to ensure a good fit, the athletic glove system 5 is fitted tightly to the human hand 1. Optionally, the athletic golf glove system 5 of FIG. 2 includes a fitting adjustment 14″ for variably tightening the fit of the overall golf glove system 5 to the human hand 1.

In one exemplary embodiment the flexible material is composed of either natural or synthetic fabric, natural materials such as leather, and synthetic membranes such made from polyester or nylon. In one exemplary embodiment the flexible body is composed of a moisture wicking fabric engineered to draw moisture away from the skin through capillary action and increased evaporation over a wider surface area, such as COOLMAX by Invista Corporation of Wichita, Kans.

The front portion 15 as shown in FIG. 3 includes a palm area 15′ whereas the back portion 14 shown in FIG. 1 includes a knuckle area 14′. Both the palm area 15′ and the knuckle area 14′ are each configured to receive the palm and knuckle contours of the human hand 1, respectively.

The golf glove system 5 further includes a plurality of glove stalls 21. Each glove stall of the plurality of glove stalls 21 is configured to receive the contours of the digits provided by the human hand 1.

The plurality of glove stalls 21 includes a finger glove stall 22 and a thumb glove stall 33. The finger glove stall 22 and the thumb glove stall 33 are each attached to and project from the hollow flexible body member 10 opposite the access portion 11.

As shown in FIG. 4, the finger glove stall 22 receives a finger 3 of the human hand 1. The finger glove stall 22 includes an inner finger surface 23, shown in FIG. 4a as contacting the skin 2, and an outer finger surface 24, shown as adjacent to and interfacing with the capacitive touchscreen 9.

Optionally, in at least one exemplary embodiment, the finger glove stall 22 further includes a conductive layer 30 positioned between the inner finger surface 23 and the outer finger surface 24 as shown in FIG. 4a. As shown in the embodiment of FIG. 1, the finger glove stall 22 includes a non-conductive portion 22′ that lacks the conductive layer 30 and a conductive layer portion 22″ that includes the conductive layer 30. Comparatively, the finger glove stall 22 for the embodiment of FIG. 3 entirely includes the conductive layer 30 having a matrix of interstices 87. Moreover, the thumb glove stall 33 for the embodiment of FIG. 3 entirely includes the conductive layer 30 having a matrix of interstices 87.

Accordingly, shown in FIGS. 5-7, the conductive layer 30 defines a matrix of interstices 87 at least one interstices 88 of the matrix of interstices 87 includes a conductive layer pathway 25. FIG. 3 shows a sections of the body member 10 with the outer finger surface partially removed to illustrate a matrix of interstices 87 defined by the conductive layer 30, in a plan view. At least one interstice 88 is provided by the matrix of interstices 87. In particular, FIG. 3 shows a finger glove stall 22 and a thumb glove stall each illustrating a matrix of interstices defined by respective conductive layers 30.

Identical to the flexible body member 10 described above, the conductive layer 30, in one exemplary embodiment, defined by a moisture wicking fabric engineered to draw moisture away from the skin through capillary action and increased evaporation over a wider surface area, such as COOLMAX by Invista Corporation of Wichita, Kans. Alternatively, in at least one other exemplary embodiment, the conductive layer 30 is defined by a flexible layer that defines a matrix of interstices. Illustratively, the alternative conductive layer 30 can be defined by natural or synthetic rubbers, rayons, polymers such as among others neoprene and nylon.

In one embodiment, the at least one interstices defines the conductive layer pathway 25. The conductive layer pathway 25 is configured to move electrically conductive body fluids 44 emitted by the skin 2 of the human hand 1 from the inner surface 23 to the outer surface 24. In one exemplary embodiment, the conductive layer pathway 25 is configured to promote capillary action to move electrically conductive bodily fluids 44 emitted by the skin 2 of the human hand 1 from the inner surface 23 to the outer finger surface 24.

In operation, the skin 2 has dielectric properties due at least in part to dissolve salts associated with the skin 2. Fluids emitted from the skin 2 having dissolved salts, such as perspiration and blood from microvessels, are reliably emitted by the skin 2 of the human hand 1 during athletic activity. Accordingly, the golf glove system 5 capitalizes on the constant flow of electrically conductive fluids 44, such as among others perspiration from the skin 2, to establish an electrically conductive pathway to interface with a capacitive touchscreen 9. Structurally, the conductive layer pathway 25 maintains electroconductivity to the skin 2 surface 2a as the human hand 1 is emitting conductive fluids 44 during athletic and sporting activities.

FIG. 5 illustrates a conductive layer pathway 25 that is configured to quickly draw perspiration from a perspiration gland 22b (as one exemplary illustration of an electrically conductive bodily fluid 44) quickly through the conductive layer 30 to deposit on the outer finger surface 23 thereby promoting a change in capacitance to activate the touchscreen surface 9a for operative interface with the capacitive touchscreen surface 9a thereof. As shown in the embodiment of FIG. 5, the conductive layer pathway surface 25a is curved to promote rapid flow (shown as flow arrow 35) of electrically conductive fluids 44, such as perspiration, rapidly through the conductive layer 30.

FIG. 6 illustrates a collector layer 36 coupled to the conductive layer pathway 25. As shown, the collector layer 36, at the conductive layer pathway 25, is disposed on the at least one interstice 88 of the matrix of interstices 87. In operation, the collector layer 36 receives electrically conductive bodily fluids 44 traveling from the inner finger surface 23 to the outer finger surface 24, as shown by flow arrow 35.

The collector layer 36 includes a collecting body 36aa for storing the electrically conductive bodily fluids 44. In one exemplary embodiment, the collecting body 36aa is composed of Polyacrylamide (a polymerization of acrylamide (C₃H₅NO)). During fabrication of the collector layer 36, a deposition of Polyacrylamide flocculant is set on at least one interstice 88 of the matrix of interstices 87 to form the collecting body 36aa. The polyacrylamide flocculant is a nontoxic yet absorbent material with electric properties for receiving and storing electrically conductive bodily fluids 44 that include dissolved salts.

In operation, the collector layer 36 includes a collector layer pathway 37 defined by the stored electrically conductive bodily fluids 44 (such as perspiration generated by at least one perspiration gland 2b) at the collecting body 36. As shown in FIG. 6, the collector layer pathway 37 touches the skin 2 of the human hand 1 at the inner finger surface 23 and continues to the outer finger surface 24 to operate the capacitive touchscreen 9 at the capacitive touchscreen surface 9a. As shown in FIG. 6, the conductive layer pathways 25 and the collector layer pathway 37 draw electrically conductive bodily fluids 44 away from the skin 2 over a wide surface area of contact adjacent to the touchscreen surface 9a to promote the distribution of conductive salts as close to the capacitive touchscreen 9 as possible.

In another exemplary embodiment, the collector layer 36 includes a collector valve 39 as shown in FIG. 7. In one embodiment, the collector layer 36 defines the collector valve 39. The collector valve of FIG. 7 is disposed, adjacent to the outer finger surface 24, on at least one interstice 88, the collector valve 39 is composed at least in part of polyacrylamide (C₃H₅NO)ₙ.

In one exemplary embodiment, the collector valve 39 defines a check valve 39 (i.e. a no-return or one-way valve). The collector valve 39 receives electrically conductive bodily fluids 44 and regulates the flow of electrically conductive bodily fluids discharged by the collector valve 39 (shown as flow arrow 35) at the outer finger surface 24. In one exemplary embodiment, the collector valve 39 applies isoelectric focusing at a predetermined rate to regulate electrically conductive body fluid flow 44 to open and close the collector valve 39 to regulate the flow (shown as flow arrow 35). Moreover, in addition to regulating fluid flow, the collector valve 39, in one embodiment, stores the electrically conductive bodily fluids 44.

As shown in FIGS. 1 and 4, the thumb glove stall 33 is provided to receive the thumb of a human hand 1. In one embodiment, the finger glove stall 22 is configured to accommodate the contours of the fingers of the human hand 1 whereas the thumb glove stall 33 is configured to accommodate the contours of the thumb of the human hand 1. Identical to the finger glove stall 22 discussed above, the thumb glove stall 33 includes an inner thumb surface, an outer thumb surface, and a conductive layer. Shown in FIG. 3, the conductive layer 30 defines a matrix of interstices 87, at least one interstice of matrix of interstices is configured to transfer electrically conductive bodily fluids 44 emitted by the skin 2 of the human hand 1 from the inner thumb surface to the outer thumb surface. The electrically conductive bodily fluids 44 at the outer thumb surface establish a change in capacitance at the capacitive touchscreen surface 9a to operate the capacitive touchscreen 9.

Optionally shown in FIG. 3, another finger glove stall 22aa, in addition to the finger glove stall 22 discussed above, includes an inner finger surface, an outer finger surface, and a conductive layer. Identical to the finger glove stall 22 discussed above, the another finger glove stall 22a includes the conductive layer positioned between the inner and outer layer finger surfaces. The conductive layer 30 of FIG. 3 defines the matrix of interstices 87, at least one interstice 88 of the matrix of interstices 87 includes a conductive layer pathway 25 configured to move electrically conductive bodily fluids 44 (shown as flow arrow 35).

Further embodiments are appreciated below as follows. An athletic glove system 5 for receiving a human hand and configured to interface with a capacitive touchscreen 9 as a human hand 1 is received by the athletic glove is appreciated as follows. The athletic glove system 5 includes a hollow flexible body member and a plurality of glove stalls 21. The hollow flexible body member has an access portion, a front portion, and a back portion. The front portion includes a palm area and the back portion includes a knuckle area.

The plurality of glove stalls includes a finger glove stall and a thumb glove stall each attached to and projecting from the flexible body member opposite the access portion. The finger glove stall includes an inner finger surface, an outer finger surface, and a conductive layer positioned between the inner and outer finger surfaces. In other embodiments some or all of the glove stalls can include the conductive layer. The conductive layer defines a matrix of interstices. At least one interstice of the matrix of interstices includes a conductive layer pathway configured to move electrically conductive bodily fluids emitted by the skin of the human hand from the inner finger surface to the outer finger surface. The electrically conductive bodily fluids exit the conductive layer pathway at the outer finger surface and thereby establish a change in capacitance at the capacitive touchscreen to operate the touchscreen.

The athletic glove system can further include a collector layer disposed on at least one interstices of a matrix of interstices such that the collector layer receives electrically conductive bodily fluids traveling from the inner finger surface to the outer finger surface. The collector layer includes a collector layer pathway defined by the stored electrically conductive bodily fluids at the collecting body. The collector layer pathway touches the skin of the human hand at the inner finger surface and continues to the outer finger surface to operate the capacitive touchscreen.

In one further embodiment as described, an athletic glove system for receiving a human hand and configured to interface with a capacitive touchscreen as a human hand is received by the athletic glove system is appreciated as follows. The athletic glove system includes a hollow flexible body member and a plurality of glove stalls. The hollow flexible body member includes an access portion, a front portion, and a back portion. The front portion includes a palm area and the back portion includes a knuckle portion.

The plurality of glove stalls includes a finger glove stall and a thumb glove stall. Each glove stall is attached to and projects from the hollow flexible body member opposite the access portion. The finger glove stall includes an inner finger surface an outer finger surface, and a conductive layer positioned between the inner and outer finger surfaces.

The conductive layer defines a matrix of interstices. At least one interstice of the matrix of interstices includes a conductive layer pathway configured to transfer dielectric conductivity directly from the skin of the human hand. The skin 2 of the human hand 1 features dielectric properties based in part on dissolved salts provided by the skin. A conductive layer pathway is configured to transfer dielectric conductivity directly from the skin of the human hand, from the inner finger surface to the outer finger surface of the athletic glove, to thereby establish a conductive layer pathway at the outer finger surface to create a change in capacitance at the capacitive touchscreen to operate the touchscreen.

The athletic glove system includes a collector layer, disposed on at least one interstice of the matrix of interstices, for receiving electrically conductive bodily fluids traveling from the skin of the human hand from the inner finger surface to the outer finger surface. The collector layer includes a collector layer pathway defined by the stored electrically conductive bodily fluids at the collecting body. The collecting layer pathway touches the skin of the human hand at the inner finger surface and continues to the outer finger surface to operate the capacitive touchscreen.

Although the present invention has been described in detail, it should be understood that various changes, substitutions, and alterations could be made hereto without departing from the spirit and scope of the invention as defined by the appended claims.

We claim:

1. A golf glove for receiving a human hand, the golf glove configured to interface with a capacitive touchscreen as the human hand is received by the golf glove, the golf glove comprising:
a hollow flexible body member, the hollow flexible body member having an access portion, a front portion, and a back portion,
the front portion includes a palm area and the back portion includes a knuckle area;
a plurality of glove stalls, the plurality of glove stalls includes a finger glove stall and a thumb stall, each attached to and projecting from the hollow flexible body member opposite the access portion;
the finger glove stall including of an inner finger surface, an outer finger surface and a conductive layer positioned between the inner and outer finger surfaces,
the conductive layer defining a matrix of interstices,
at least one interstice of the matrix of interstices includes a conductive layer pathway configured to move electrically conductive bodily fluids emitted by the skin of the human hand from the inner finger surface to the outer finger surface,
the electrically conductive bodily fluids exiting the conductive layer pathway at the outer finger surface establish a change in capacitance at the capacitive touchscreen to operate the touchscreen.

2. The golf glove according to claim 1 further comprising a collector layer, disposed on the at least one interstice of the matrix of interstices, the collector layer receives electrically conductive bodily fluids traveling from the inner finger surface to the outer finger surface.

3. The golf glove according to claim 2 wherein the collector layer includes a collecting body for storing the electrically conductive bodily fluids.

4. The golf glove according to claim 3 wherein the collector layer includes a collector layer pathway defined by the stored electrically conductive bodily fluids at the collecting body.

5. The golf glove according to claim 2 wherein the collector layer pathway touches the skin of the human hand at the inner finger surface and continues to the outer finger surface to operate the capacitive touchscreen.

6. The golf glove according to claim 2 wherein the collector layer defines a collector valve disposed, adjacent to the outer finger surface, on the at least one interstice, the collector valve composed of polyacrylamide.

7. The golf glove according to claim 6 wherein the collector valve defines a check valve.

8. The golf glove according to claim 6 wherein the collector valve receives electrically conductive bodily fluids and regulates the flow of the electrically conductive bodily fluids discharged by the collector valve at the outer finger surface.

9. The golf glove according to claim 6 wherein the collector valve applies isoelectric focusing to regulate electrically conductive bodily fluid flow.

10. The golf glove according to claim 6 wherein the collector valve stores the electrically conductive bodily fluids.

11. The golf glove according to claim 1 wherein the thumb glove stall includes an inner thumb surface, an outer thumb surface and a conductive layer, the conductive layer defining a matrix of interstices, at least one interstice of the matrix of interstices is configured to transfer electrically conductive bodily fluids emitted by the skin of the human hand from the inner thumb surface to the outer thumb surface, the electrically conductive bodily fluids at the outer thumb surface establish a change in capacitance at the capacitive touchscreen to operate the touchscreen.

12. The golf glove according to claim 1 further comprising another finger glove stall including of an inner finger surface, an outer finger surface and a conductive layer, the conductive layer positioned between the inner and outer finger surfaces the conductive layer defining a matrix of interstices, at least one interstice of the matrix of interstices includes a conductive layer pathway configured to move electrically conductive bodily fluids.

13. An athletic glove for receiving a human hand, the athletic glove configured to interface with a capacitive touchscreen as the human hand is received by the athletic glove, the athletic glove comprising
a hollow flexible body member, the hollow flexible body member having an access portion, a front portion, and a back portion,
the front portion includes a palm area and the back portion includes a knuckle area;
a plurality of glove stalls, the plurality of glove stalls includes a finger glove stall and a thumb stall, each attached to and projecting from the hollow flexible body member opposite the access portion;
the finger glove stall includes an inner finger surface, an outer finger surface, and a conductive layer positioned between the inner and outer finger surfaces,
the conductive layer defining a matrix of interstices,
at least one interstice of the matrix of interstices includes a conductive layer pathway configured to move electrically conductive bodily fluids emitted by the skin of the human hand from the inner finger surface to the outer finger surface,
the electrically conductive bodily fluids exiting the conductive layer pathway at the outer finger surface to establish a change in capacitance at the capacitive touchscreen to operate the touchscreen.

14. The athletic glove according to claim 13 further comprising a collector layer, disposed on the at least one interstice of the matrix of interstices, the collector layer receives electrically conductive bodily fluids traveling from the inner finger surface to the outer finger surface.

15. The athletic glove according to claim 14 wherein the collector layer includes a collector layer pathway defined by the stored electrically conductive bodily fluids at the collecting body.

16. The athletic glove according to claim 15 wherein the collector layer pathway touches the skin of the human hand at the inner finger surface and continues to the outer finger surface to operate the capacitive touchscreen.

17. An athletic glove for receiving a human hand, the athletic glove configured to interface with a capacitive touchscreen as the human hand is received by the athletic glove, the athletic glove comprising
a hollow flexible body member, the hollow flexible body member having an access portion, a front portion, and a back portion,
the front portion includes a palm area and the back portion includes a knuckle area;
a plurality of glove stalls, the plurality of glove stalls includes a finger glove stall and a thumb stall, each attached to and projecting from the hollow flexible body member opposite the access portion;
the finger glove stall including of an inner finger surface, an outer finger surface and a conductive layer positioned between the inner and outer finger surfaces,
the conductive layer defining a matrix of interstices,
at least one interstice of the matrix of interstices includes a conductive layer pathway configured to transfer dielectric conductivity directly from the skin of the human hand from the inner finger surface to the outer finger surface,
the conductive layer pathway at the outer finger surface establish a change in capacitance at the capacitive touchscreen to operate the touchscreen.

18. The athletic glove according to claim 17 further comprising a collector layer, disposed on the at least one interstice of the matrix of interstices, the collector layer receives electrically conductive bodily fluids traveling from the inner finger surface to the outer finger surface.

19. The athletic glove according to claim 18 wherein the collector layer includes a collector layer pathway defined by the stored electrically conductive bodily fluids at the collecting body.

20. The athletic glove according to claim 19 wherein the collector layer pathway touches the skin of the human hand at the inner finger surface and continues to the outer finger surface to operate the capacitive touchscreen.
